(19) United States
(12) Patent Application Publication
(10) Pub. No.: US 2024/0402730 A1
(43) Pub. Date: Dec. 5, 2024

(54) SYSTEM AND METHOD

(71) Applicant: TOYOTA JIDOSHA KABUSHIKI KAISHA, Toyota-shi (JP)

(72) Inventors: Keigo IKEDA, Nisshin-shi (JP); Yasuhiro SAITO, Toyoake-shi (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/674,331

(22) Filed: May 24, 2024

(30) Foreign Application Priority Data
May 29, 2023 (JP) 2023-087409
Jan. 17, 2024 (JP) 2024-005039

(51) Int. Cl. G05D 1/80; G05D 1/242; G05D 1/246; G05D 1/249; G05D 111/10

(52) U.S. Cl. CPC G05D 1/80; G05D 1/246; G05D 1/249; G05D 1/242; G05D 2111/14

(57) ABSTRACT

A system includes a mobile body detector configured to detect mobile body information, a position estimation unit configured to estimate at least any one of a position and an orientation of the mobile body, a controller configured to generate a control command for causing the mobile body to travel via remote control, and a blind spot detector configured to detect blind spot information.

### CROSS-REFERENCE TO RELATED APPLICATION

This application claims priority to Japanese Patent Application No. 2023-087409filed on May 29, 2023 and Japanese Patent Application No. 2024-005039 filed on Jan. 17, 2024, each incorporated herein by reference in its entirety.

### BACKGROUND

### 1. Technical Field

The present disclosure relates to a technique for moving a mobile body by unmanned driving.

### 2. Description of Related Art

For example, Japanese Unexamined Patent Application Publication (Translation of PCT Application) No. 2017-538619 (JP 2017-538619 A) discloses a vehicle travel method of causing a vehicle to travel in a manufacturing system for manufacturing the vehicle from a terminal of an assembly line of the manufacturing system to a parking lot of the manufacturing system via remote control.

### SUMMARY

When a mobile body, such as a vehicle, is moved by remote control, processing of estimating a position or an orientation of the mobile body can be executed. In the estimation of the position or the orientation of the mobile body, data of the mobile body detected by a detector, such as a camera or a sensor, may be used. However, depending on a positional relationship between the mobile body and the detector, a blind spot that cannot be detected by the detector may be generated in the vicinity of the mobile body. Therefore, a technique for detecting an object or the like existing in the blind spot in the surroundings of the mobile body is desired.

The present disclosure can be implemented as the following aspects.

A first aspect of the present disclosure relates to a system configured to move a mobile body via unmanned driving. The system includes at least one mobile body detector, a position estimation unit, a controller, and at least one blind spot detector. The at least one mobile body detector is configured to detect mobile body information including at least any one of an image of the mobile body and three-dimensional point cloud data of the mobile body. The position estimation unit is configured to estimate at least any one of a position and an orientation of the mobile body by using the detected mobile body information. The controller is configured to generate a control command for causing the mobile body to travel by using the estimated position and orientation of the mobile body. The at least one blind spot detector is configured to detect blind spot information including at least any one of an image of a blind spot of the mobile body that is not detected by the mobile body detector, three-dimensional point cloud data of the blind spot, and existence of an object in the blind spot.

With the system according to the first aspect, the object or the like existing in the blind spot generated in the surroundings of the mobile body can be detected by the blind spot detector that acquires the blind spot information.

In the system according to the first aspect, the at least one blind spot detector may include a plurality of the blind spot detectors, and the system may further include a blind spot detector decision unit configured to decide the blind spot detector that is able to detect the blind spot information corresponding to the blind spot for each position of the mobile body with respect to the mobile body detector among the blind spot detectors.

With the system according to the first aspect, the blind spot information of the blind spot that dynamically changes in response to the movement of the mobile body can be detected by appropriately switching the blind spot detector for each position of the mobile body that travels.

The system according to the first aspect may further include a blind spot estimation unit configured to estimate a position of the blind spot depending on a relative position of the mobile body to the mobile body detector.

With the system according to the first aspect, the blind spot information of the blind spot that dynamically changes in response to the movement of the mobile body can be detected.

In the system according to the first aspect, the blind spot estimation unit may be configured to estimate the position of the blind spot by regarding, among straight lines passing through the mobile body and directed from the mobile body detector toward the mobile body, a set on a side opposite to the mobile body detector across the mobile body as the blind spot.

With the system according to the first aspect, the position of the blind spot can be easily estimated.

In the system according to the first aspect, the at least one mobile body detector and the at least one blind spot detector may include different kinds of detectors.

With the system according to the first aspect, the object existing in the blind spot can be detected from a plurality of directions by using different kinds of detectors.

In the system according to the first aspect, the at least one mobile body detector may be any one of a distance measurement device and a camera, and the at least one blind spot detector may be the other of the distance measurement device and the camera.

According to the first aspect, the distance measurement device and the camera can be used as different kinds of detectors.

The system according to the first aspect may further include a composite map generation unit configured to generate a composite map by composing the detected mobile body information and the detected blind spot information, and a surrounding monitoring unit configured to monitor surroundings of the mobile body. The generated composite map may be used for both surrounding monitoring via the surrounding monitoring unit and movement control for the mobile body via the controller.

With the system according to the first aspect, the processing of the movement control and the processing of the surrounding monitoring are easily simultaneously executed by using a common map in the movement control for the mobile body and the surrounding monitoring of the mobile body.

A second aspect of the present disclosure relates to a method of moving a mobile body via unmanned driving. The method includes detecting, via at least one mobile body detector, mobile body information including at least any one of an image of the mobile body and three-dimensional point cloud data of the mobile body. The method includes estimating at least any one of a position and an orientation of the mobile body by using the detected mobile body information. The method includes generating a control command for causing the mobile body to travel by using the estimated position and orientation of the mobile body. The method includes detecting, via at least one blind spot detector, blind spot information including at least any one of an image of a blind spot of the mobile body that is not detected by the mobile body detector, three-dimensional point cloud data of the blind spot, and existence of an object in the blind spot.

With the method according to the second aspect, the object or the like existing in the blind spot generated in the surroundings of the mobile body can be detected by the blind spot detector that acquires the blind spot information.

The present disclosure can also be implemented in various aspects other than the system and the method. For example, the present disclosure can be implemented in aspects, such as a control device, a method of moving a mobile body, a method of manufacturing a mobile body, a method of monitoring surroundings of a mobile body, a blind spot detection device, a method of detecting a blind spot, a method of controlling a system, a method of controlling a control device, a computer program that implements the control method, and a non-transitory recording medium on which the computer program is recorded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to a first embodiment;

FIG. 2A is a flowchart illustrating a processing routine for autonomous driving of a vehicle and surrounding monitoring;

FIG. 2B is a flowchart illustrating a processing procedure of traveling control for the vehicle according to the first embodiment;

FIG. 3 is a diagram schematically illustrating an example of a method of acquiring blind spot information during traveling of the vehicle;

FIG. 4 is a diagram illustrating an overall configuration of a system according to a second embodiment;

FIG. 5 is a diagram illustrating an overall configuration of a system according to a third embodiment in a top view;

FIG. 6 is a block diagram illustrating a functional configuration of a control device; and

FIG. 7 is a flowchart illustrating a processing procedure of traveling control for a vehicle according to a fourth embodiment.

### DETAILED DESCRIPTION OF EMBODIMENTS

### A. First Embodiment

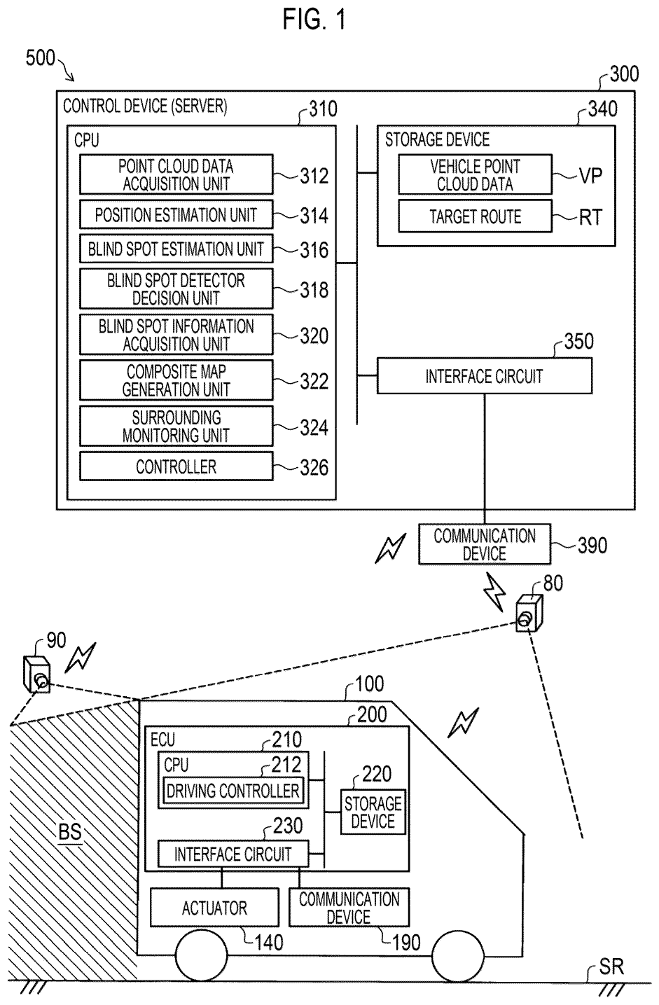

FIG. 1 is a diagram illustrating a schematic configuration of a system 500 according to a first embodiment of the present disclosure. The system 500 includes vehicle detectors 80 as one or more mobile body detectors, one or more blind spot detectors 90, and a control device 300. The control device 300 generates a control command for moving a vehicle 100 as a mobile body via unmanned driving, and transmits the generated control command to the vehicle 100. The system 500 is used in, for example, a factory that manufactures the vehicle 100 that can be moved by the unmanned driving. The vehicle detector 80 and the blind spot detector 90 are external sensors disposed outside the vehicle 100.

Examples of the vehicle 100 include a passenger car, a truck, a bus, and a construction vehicle. The vehicle 100 is preferably a battery electric vehicle (BEV). The vehicle 100 is not limited to the battery electric vehicle, and may be, for example, a gasoline vehicle, a hybrid electric vehicle, or a fuel cell electric vehicle. The vehicle 100 includes a vehicle communication device 190, an actuator 140, and an electronic control unit (ECU) 200. The vehicle communication device 190 executes wireless communication with an external device of the vehicle 100 connected to a network, such as the control device 300, via an access point or the like in the factory.

The vehicle 100 is configured to travel via the unmanned driving. The “unmanned driving” means driving that does not depend on a traveling operation of an occupant. The traveling operation means an operation related to at least any one of “traveling”, “turning”, and “stopping” of the vehicle 100. The unmanned driving is implemented by automatic or manual remote control using a device located outside the vehicle 100 or by autonomous control for the vehicle 100. The occupant who does not perform the traveling operation may get in the vehicle 100 that travels via the unmanned driving. Examples of the occupant who does not perform the traveling operation include a person who simply sits on a seat of the vehicle 100 and a person who executes work different from the traveling operation, such as assembly, inspection, or operation of switches, in a state of getting in the vehicle 100. The driving via the traveling operation of the occupant may be referred to as “manned driving”.

In the present specification, the “remote control” includes “complete remote control” in which all the operations of the vehicle 100 are completely decided from the outside of the vehicle 100, and “partial remote control” in which a part of the operations of the vehicle 100 is decided from the outside of the vehicle 100. In addition, the “autonomous control” includes “complete autonomous control” in which the vehicle 100 autonomously controls the operation thereof without receiving any information from the external device of the vehicle 100, and “partial autonomous control” in which the vehicle 100 autonomously controls the operation thereof by using the information received from the external device of the vehicle 100.

The ECU 200 is mounted on the vehicle 100 and executes various controls of the vehicle 100. The ECU 200 includes a storage device 220, such as a hard disk drive (HDD), a solid state drive (SSD), an optical recording medium, or a semiconductor memory, a CPU 210 as a central processing unit, and an interface circuit 230. The CPU 210, the storage device 220, and the interface circuit 230 are connected to each other to be bidirectionally communicable with each other via an internal bus. The actuator 140 and the vehicle communication device 190 are connected to the interface circuit 230.

A writable area of the storage device 220 stores a computer program for implementing at least a part of the functions provided in the present embodiment. The CPU 210 executes various computer programs stored in a memory to implement functions of a driving controller 212 and the like.

The driving controller 212 executes driving control for the vehicle 100. The “driving control” means various controls for driving each actuator 140 that exhibits the functions of “traveling”, “turning”, and “stopping” of the vehicle 100, such as acceleration, speed, and steering angle adjustment. In the present embodiment, the actuator 140 includes an actuator of a drive device for accelerating the vehicle 100, an actuator of a steering device for changing a traveling direction of the vehicle 100, and an actuator of a braking device for decelerating the vehicle 100. The drive device includes a battery, a traveling motor driven by power of the battery, and drive wheels rotated by the traveling motor. The actuator of the drive device includes the traveling motor. The actuator 140 may further include an actuator for rocking a windshield wiper of the vehicle 100 or an actuator for opening and closing an electric window of the vehicle 100.

The driving controller 212 can cause the vehicle 100 to travel by controlling the actuator 140 in response to an operation of a driver in a case where the driver gets in the vehicle 100. The driving controller 212 can also cause the vehicle 100 to travel by controlling the actuator 140 in response to the control command transmitted from the control device 300 regardless of whether or not the driver gets in the vehicle 100.

The vehicle detector 80 is a device that detects vehicle information as mobile body information. The “vehicle information” is various information for estimating at least any one of a position of the vehicle 100 and an orientation of the vehicle 100. In the present embodiment, the vehicle information is three-dimensional point cloud data of the vehicle 100. The three-dimensional point cloud data is data indicating a three-dimensional position of a point cloud. The vehicle detector 80 uses a light detection and ranging (LiDAR) as a distance measurement device that measures the three-dimensional point cloud data of the vehicle 100. By using the LiDAR, highly accurate three-dimensional point cloud data can be acquired. The position of the vehicle 100 may be solely acquired by the vehicle detector 80, and a temporal change of the vehicle 100 or the like may be acquired to estimate the orientation or the traveling direction of the vehicle 100.

The vehicle detector 80 is communicably connected to the control device 300 via wireless communication or wired communication. The control device 300 can acquire the relative position and orientation of the vehicle 100 to a target route RT in real time by acquiring the three-dimensional point cloud data from the vehicle detector 80. In the present embodiment, the position of the vehicle detector 80 is fixed in a vicinity of a travel road SR, and a relative relationship between a reference coordinate system Σr and a device coordinate system of the vehicle detector 80 is known. A coordinate transformation matrix for mutually transforming a coordinate value of the reference coordinate system Σr and a coordinate value of the device coordinate system of the vehicle detector 80 is stored in the control device 300 in advance.

The blind spot detector 90 is a device that acquires blind spot information. The “blind spot information” is various information on the blind spot BS in the surroundings of the vehicle 100 that is not detected by the vehicle detector 80. The blind spot information is used to detect an object existing in the blind spot BS. The “blind spot BS” can be defined as, for example, a set of portions on a side opposite to the vehicle detector 80 across the vehicle 100 among straight lines directed from the vehicle detector 80 toward the vehicle 100 and passing through the vehicle 100, as illustrated in FIG. 1. The blind spot BS need solely be at least an area used for the surrounding monitoring for the vehicle 100. In a case where all the blind spot information in the blind spot BS cannot be acquired by a single blind spot detector 90, another blind spot detector may be further added, and one blind spot information may be acquired by a plurality of the blind spot detectors 90. In the present embodiment, the blind spot information is the three-dimensional point cloud data including the blind spot BS. The same kind of the LiDAR as the vehicle detector 80 is used for the blind spot detector 90. Note that, as will be described below, the blind spot detector 90 and the vehicle detector 80 may be different kinds of detectors. In a case where the blind spot detector 90 and the vehicle detector 80 are the same kind of detector, one detector may have a function of the blind spot detector 90 and a function of the vehicle detector 80, and the functions may be appropriately switched depending on a traveling position of the vehicle 100.

The control device 300 is a server that executes the driving control for the vehicle 100 via remote control and the surrounding monitoring for the vehicle 100. The control device 300 executes, for example, transport of the vehicle 100 in a manufacturing process in the factory by autonomously driving the vehicle 100 via the remote control. The transport of the vehicle 100 using the autonomous driving via the remote control is also referred to as “autonomous transport”. Due to the autonomous transport, the vehicle 100 can be moved without using a transport device, such as a crane or a conveyor.

The control device 300 includes a CPU 310 as a central processing unit, a storage device 340, an interface circuit 350, and a remote communication device 390. The CPU 310, the storage device 340, and the interface circuit 350 are connected to each other to be bidirectionally communicable with each other via an internal bus. The remote communication device 390 is connected to the interface circuit 350. The remote communication device 390 communicates with the vehicle 100 via a network or the like.

The storage device 340 is, for example, a RAM, a ROM, an HDD, or an SSD. The storage device 340 stores vehicle point cloud data VP and the target route RT. The vehicle point cloud data VP is, for example, three-dimensional CAD data of the vehicle 100. The vehicle point cloud data VP includes information for specifying the orientation of the vehicle 100. The target route RT is a traveling route of the vehicle 100 determined in advance on the travel road SR.

By the CPU 310 executing the computer program stored in the storage device 340, the CPU 310 functions as a point cloud data acquisition unit 312, a position estimation unit 314, a blind spot estimation unit 316, a blind spot detector decision unit 318, a blind spot information acquisition unit 320, a composite map generation unit 322, a surrounding monitoring unit 324, and a controller 326. Note that a part or all of these functions may be configured by a hardware circuit. The point cloud data acquisition unit 312 acquires the three-dimensional point cloud data measured by the vehicle detector 80.

The position estimation unit 314 estimates a position and an orientation of the vehicle 100 in the traveling environment including the travel road SR by using the acquired three-dimensional point cloud data. In the present embodiment, the position estimation unit 314 estimates the position and the orientation of the vehicle 100 by executing template matching using the vehicle point cloud data VP as a template stored in the storage device 340. For the template matching, for example, an iterative closest point (ICP) algorithm or a normal distribution transform (NDT) algorithm can be used. The position estimation unit 314 may directly extract the position and the orientation of the vehicle 100 from the acquired three-dimensional point cloud data, instead of the template matching.

The blind spot estimation unit 316 estimates a position of the blind spot BS in the surroundings of the vehicle 100. The blind spot estimation unit 316 estimates the position of the blind spot BS of the vehicle 100, for example, by using the relative position between the vehicle 100 and the vehicle detector 80 in the measured three-dimensional point cloud data. The “position of the blind spot BS” may be information on three-dimensional coordinates of an area corresponding to the blind spot BS, or may be simple information, such as a direction in which the blind spot BS exists with respect to the vehicle 100. The blind spot BS may be estimated as an area in which the three-dimensional point cloud data in the surroundings of the vehicle 100 is not measured. For example, the blind spot estimation unit 316 may estimate the position of the blind spot BS by regarding, among the straight lines directed from the vehicle detector 80 toward the vehicle 100 and passing through the vehicle 100, a set (area) on the side opposite to the vehicle detector 80 across the vehicle 100 as the blind spot BS.

The blind spot detector decision unit 318 decides the blind spot detector 90 for detecting the blind spot information from the blind spot detectors 90. The blind spot detector decision unit 318 decides the blind spot detector 90 corresponding to the position of the blind spot BS estimated by the blind spot estimation unit 316. In the present embodiment, the blind spot detector decision unit 318 checks a detection range that can be detected by each of the blind spot detectors 90, and decides the blind spot detector 90 having the detection range including the blind spot BS as the blind spot detector 90 corresponding to the position of the blind spot BS. In a case where the position of the blind spot BS is simple information, such as the direction in which the blind spot BS exists with respect to the vehicle 100, the blind spot detector 90 located in the direction, or the blind spot detector 90 that can detect the area including the direction may be decided.

The blind spot information acquisition unit 320 acquires the three-dimensional point cloud data of the area including the blind spot BS as the blind spot information by using the decided blind spot detector 90. The composite map generation unit 322 generates a composite map in which the three-dimensional point cloud data acquired by the point cloud data acquisition unit 312 and the three-dimensional point cloud data of the blind spot BS acquired by the blind spot information acquisition unit 320 are composed. As a result, the composite map in which the blind spot information is supplemented can be generated. The surrounding monitoring unit 324 executes the surrounding monitoring for the vehicle 100, such as detection of an obstacle in the surroundings of the vehicle 100, by using the generated composite map.

The controller 326 generates a control command (traveling control signal) for the remote control by using the estimated position and orientation of the vehicle 100. The controller 326 transmits the generated control command to the vehicle 100. The control command is a command for causing the vehicle 100 to travel along the target route RT stored in the storage device 340. The control command can be generated as a command including a driving force or a braking force, and the steering angle. Alternatively, the control command may be generated as a command including at least one of the position and the orientation of the vehicle 100 and a future traveling route. In a case where the vehicle 100 receives a request for the remote control, the driving control is implemented by the driving controller 212 of the ECU 200, and as a result, the vehicle 100 performs the autonomous driving.

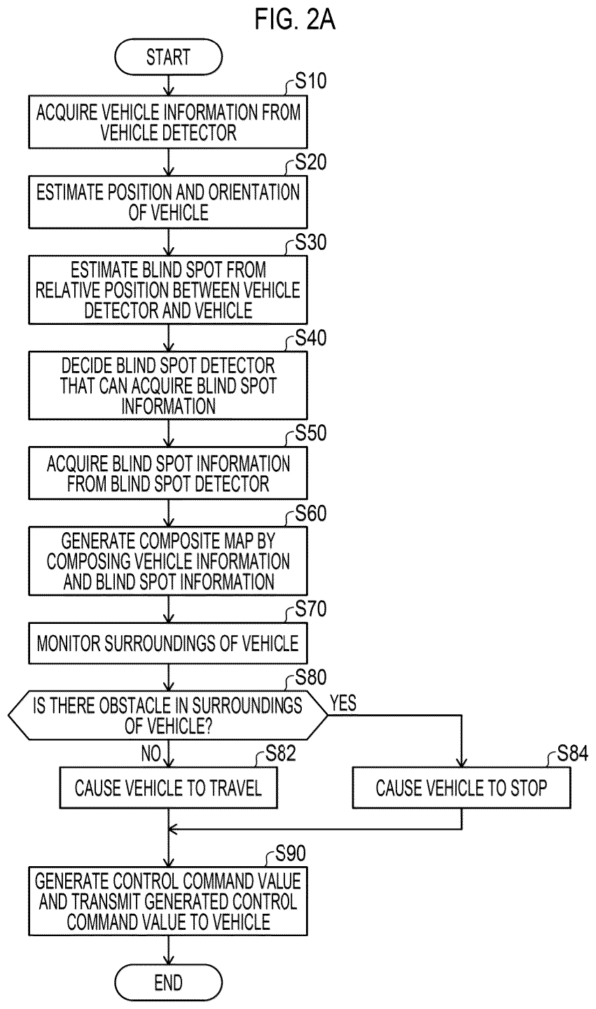

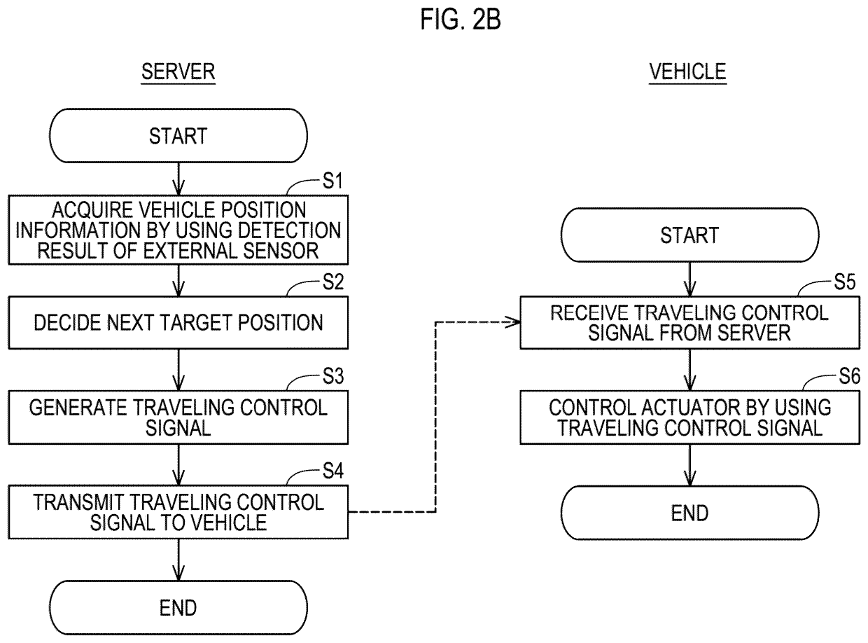

FIG. 2A is a flowchart illustrating a processing routine of the autonomous driving of the vehicle 100 via the remote control and the surrounding monitoring of the vehicle 100. The present flow is started when the vehicle 100 starts traveling on the travel road SR. The present flow can be repeatedly executed each time the point cloud data acquisition unit 312 newly acquires the three-dimensional point cloud data from the vehicle detector 80 that is in charge of the measurement of the vehicle 100 as a control target. The point cloud data acquisition unit 312 may execute preprocessing of removing background point cloud data indicating a stationary object from the newly acquired three-dimensional point cloud data.

In step S10, the point cloud data acquisition unit 312 acquires the three-dimensional point cloud data as the vehicle information from the vehicle detector 80. In step S20, the position estimation unit 314 estimates the position and the orientation of the vehicle 100 by using the acquired three-dimensional point cloud data. In step S30, the blind spot estimation unit 316 estimates the position of the blind spot BS in the surroundings of the vehicle 100 by using the relative position between the vehicle detector 80 that is in charge of the measurement of the vehicle 100 and the vehicle 100 in the measured three-dimensional point cloud data.

In step S40, the blind spot detector decision unit 318 decides the blind spot detector 90 that can acquire the blind spot information of the estimated blind spot BS. In step S50, the three-dimensional point cloud data of the area including the blind spot BS is acquired as the blind spot information by using the decided blind spot detector 90.

In step S60, the composite map generation unit 322 generates the composite map obtained by composing the three-dimensional point cloud data acquired by the point cloud data acquisition unit 312 and the three-dimensional point cloud data of the blind spot BS acquired by the blind spot information acquisition unit 320. In the present embodiment, the generated composite map is used for both the surrounding monitoring via the surrounding monitoring unit 324 and the traveling control (also referred to as “movement control”) for the vehicle 100 via the controller 326.

In step S70, the surrounding monitoring unit 324 executes the surrounding monitoring for the vehicle 100 by using the generated composite map. Specifically, the surrounding monitoring unit 324 monitors the composite map to detect the obstacle in the surroundings of the vehicle 100 including the blind spot BS. In step S80, the surrounding monitoring unit 324 checks whether or not there is the obstacle that obstructs the traveling of the vehicle 100 in the surroundings of the vehicle 100. When there is no obstacle in the surroundings of the vehicle 100 (S80: NO), the surrounding monitoring unit 324 proceeds with the processing to step S82, and executes output for causing the vehicle 100 to travel along the target route RT. In step S90, the controller 326 generates the control command for causing the vehicle 100 to travel along the target route RT by using the estimated position and orientation of the vehicle 100, and transmits the generated control command to the vehicle 100.

When the obstacle in the surroundings of the vehicle 100 is detected (S80: YES), the surrounding monitoring unit 324 proceeds with the processing to step S84, and executes output for causing the vehicle 100 to stop. In this case, in step S90, the controller 326 generates a control command for causing the vehicle 100 to stop, and transmits the generated control command to the vehicle 100.

FIG. 2B is a flowchart illustrating a processing procedure of the traveling control for the vehicle 100 according to the first embodiment. In step S1, the server 300 (is synonymous with the “control device 300”) acquires the vehicle position information by using the detection result output from the external sensor as the sensor located outside the vehicle 100. The vehicle position information is position information that is a basis for generating the traveling control signal. In the present embodiment, the vehicle position information includes the position and the orientation of the vehicle 100 in the reference coordinate system Σr of the factory. In the present embodiment, the reference coordinate system Σr of the factory is a global coordinate system, and any position in the factory can be expressed by X, Y, and Z coordinates in the global coordinate system. In the present embodiment, the external sensor includes at least the vehicle detector 80 installed in the factory. That is, in step S1, the server 300 acquires the vehicle position information by using the data acquired from the vehicle detector 30 as the external sensor.

Specifically, in step S1, the server 300 acquires the vehicle position information of the vehicle 100 by executing the template matching using the three-dimensional point cloud data acquired from the distance measurement device as the vehicle detector 30 and the vehicle point cloud data VP as reference point cloud data prepared in advance. In a case where the vehicle detector 30 is the camera, the server 300 detects an outer shape of the vehicle 100, calculates coordinates of a positioning point of the vehicle 100 in a captured image coordinate system, that is, a local coordinate system, and acquires the position of the vehicle 100 by transforming the calculated coordinates into the coordinates in the global coordinate system. The outer shape of the vehicle 100 included in the captured image can be detected, for example, by inputting the captured image to a detection model using artificial intelligence. The detection model is prepared, for example, inside the system 500 or outside the system 500, and is stored in advance in the storage device 340 as a memory of the server 300. Examples of the detection model include a trained machine learning model that has been trained to implement any of semantic segmentation and instance segmentation. As the machine learning model, for example, a convolutional neural network (CNN) that has been trained by supervised learning using a training data set can be used. The training data set has, for example, a plurality of training images including the vehicle 100 and a label indicating whether each area in the training image is an area indicating the vehicle 100 or an area indicating an area other than the vehicle 100. When the CNN is trained, parameters of the CNN are preferably updated by backpropagation (error backpropagation method) to reduce an error between the output result of the detection model and the label. The server 300 can acquire the orientation of the vehicle 100 by executing the estimation based on an orientation of a movement vector of the vehicle 100 calculated from a positional change of a feature point of the vehicle 100 between frames of the captured image by using, for example, an optical flow method.

In step S2, the server 300 decides a target position to which the vehicle 100 should head next. In the present embodiment, the target position is represented by the X, Y, and Z coordinates in the global coordinate system. The storage device 340 as the memory of the server 300 stores a reference route (target route RT) that is a route on which the vehicle 100 should travel in advance. The route is represented by a node indicating a departure point, a node indicating a passing point, a node indicating a destination, and a link connecting each node. The server 300 decides the target position to which the vehicle 100 should head next by using the vehicle position information and the reference route. The server 300 decides the target position on the reference route ahead of a current position of the vehicle 100.

In step S3, the server 300 generates the traveling control signal (control command value) for causing the vehicle 100 to travel toward the decided target position. In the present embodiment, the traveling control signal includes the acceleration and the steering angle of the vehicle 100 as the parameters. The server 300 calculates a traveling speed of the vehicle 100 from the transition of the position of the vehicle 100, and compares the calculated traveling speed with a target speed. As a whole, the server 300 decides the acceleration such that the vehicle 100 is accelerated when the traveling speed is lower than the target speed, and decides the acceleration such that the vehicle 100 is decelerated when the traveling speed is higher than the target speed. The server 300 decides the steering angle and the acceleration such that the vehicle 100 does not deviate from the reference route in a case where the vehicle 100 is located on the reference route, and decides the steering angle and the acceleration such that the vehicle 100 returns to the reference route in a case where the vehicle 100 is not located on the reference route, in other words, in a case where the vehicle 100 deviates from the reference route. In other embodiments, the traveling control signal may include the speed of the vehicle 100 as the parameter instead of or in addition to the acceleration of the vehicle 100.

In step S4, the server 300 transmits the generated traveling control signal to the vehicle 100. The server 300 repeatedly executes the acquisition of the vehicle position information, the decision of the target position, the generation of the traveling control signal, and the transmission of the traveling control signal at a predetermined cycle.

In step S5, the vehicle 100 receives the traveling control signal transmitted from the server 300. In step S6, the vehicle 100 controls the actuator of the vehicle 100 by using the received traveling control signal, to cause the vehicle 100 to travel at the acceleration and the steering angle indicated by the traveling control signal. The vehicle 100 repeatedly executes the reception of the traveling control signal and the control of the actuator of the vehicle 100 at a predetermined cycle. With the system 500 according to the present embodiment, the vehicle 100 can be caused to travel via the remote control, and the vehicle 100 can be moved without using transport equipment, such as a crane or a conveyor.

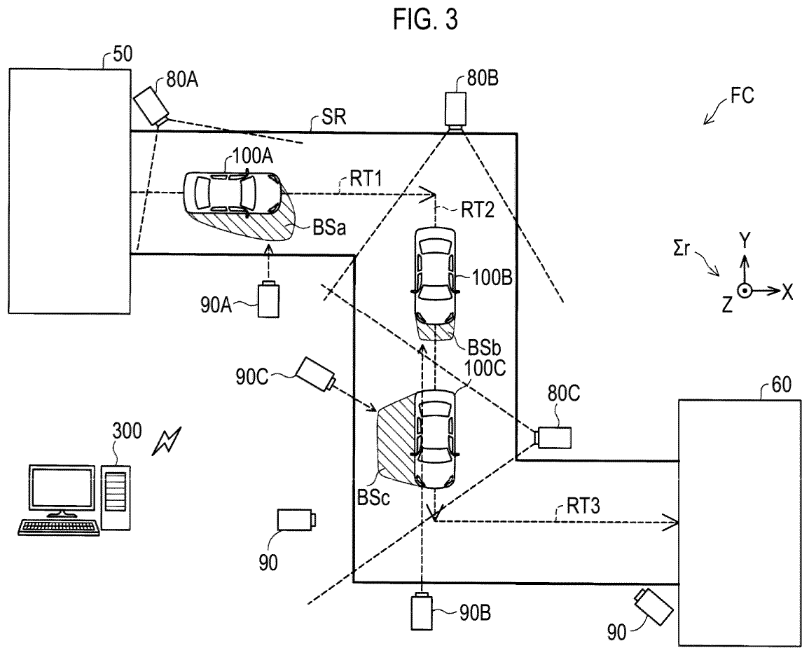

FIG. 3 is a diagram schematically illustrating an example of a method of acquiring the blind spot information during the traveling of the vehicle 100. FIG. 3 illustrates a state where the vehicle 100 is autonomously transported in a factory FC that manufactures the vehicle 100. The factory FC includes a first process 50 and a second process 60. The first process 50 is, for example, a place where the vehicle 100 is assembled, and the second process 60 is, for example, a place where the vehicle 100 is inspected. The first process 50 and the second process 60 are connected via the travel road SR on which the vehicle 100 can travel. Any position in the factory FC is represented by xyz coordinate values in the reference coordinate system Σr.

A plurality of the vehicle detectors 80 including vehicle detectors 80A, 80B, 80C is installed in the surroundings of the travel road SR, and the blind spot detectors 90 including blind spot detectors 90A, 90B, 90C that detect the three-dimensional point cloud data of blind spots BSa, BSb, BSc that are not acquired by the vehicle detectors 80A, 80B, 80C are installed. The controller 326 of the control device 300 causes the ECU 200 to execute the driving control for the vehicle 100, while analyzing the three-dimensional point cloud data of the travel road SR and the vehicle 100 acquired by the vehicle detector 80 at a predetermined time interval.

In the example of FIG. 3, the target route RT set on the travel road SR includes target routes RT1, RT2, RT3 that are continuous with each other. A vehicle 100A that departs from the first process 50 travels along the target route RT1 via the remote control using the three-dimensional point cloud data acquired by the vehicle detector 80A. In this case, a position of the blind spot BSa is estimated from a relative position between the vehicle detector 80A and the vehicle 100A, and the blind spot detector 90A for detecting the blind spot information of the estimated blind spot BSa is decided. A composite map in which the three-dimensional point cloud data acquired by the vehicle detector 80A and the three-dimensional point cloud data of the blind spot BSa acquired by the decided blind spot detector 90A are composed is generated. The vehicle 100A performs the autonomous driving along the target route RT1 via the remote control using the composite map.

When the vehicle 100A reaches the target route RT2, the vehicle detector 80A is switched to the vehicle detector 80B suitable for the detection of the vehicle 100B. A position of the blind spot BSb is estimated from a relative position between the vehicle detector 80B and the vehicle 100B, and the blind spot detector 90B corresponding to the blind spot BSb is decided. The vehicle 100B travels along the target route RT2 via the remote control using a composite map in which the three-dimensional point cloud data acquired by the vehicle detector 80B and the three-dimensional point cloud data of the blind spot BSb acquired by the blind spot detector 90B are composed.

When the vehicle 100B reaches a predetermined position on the target route RT2, similarly, the vehicle detector 80B is switched to the vehicle detector 80C suitable for the detection of the vehicle 100C. A position of the blind spot BSc is estimated from a relative position between the vehicle detector 80C and the vehicle 100C, and the blind spot detector 90C corresponding to the blind spot BSc is decided. The vehicle 100B travels to the target route RT3 via the remote control using a composite map in which the three-dimensional point cloud data acquired by the vehicle detector 80C and the three-dimensional point cloud data of the blind spot BSc acquired by the blind spot detector 90C are composed, and the same processing is executed thereafter.

As described above, the vehicle detector 80 is appropriately switched depending on the traveling position of the vehicle 100. The position of the blind spot BS is estimated from the relative position between the switched vehicle detector 80 and the traveling vehicle 100, and the blind spot detector 90 corresponding to the estimated blind spot BS is decided. The surrounding monitoring and the driving control for the vehicle 100 are executed using the composite map generated by using the decided blind spot detector 90 and the switched vehicle detector 80.

As described above, the system 500 according to the present embodiment includes the vehicle detectors 80 configured to detect the vehicle information including the three-dimensional point cloud data of the vehicle 100, the position estimation unit 314 configured to estimate the position and the orientation of the vehicle 100 by using the detected vehicle information, the controller 326 configured to generate the control command for autonomously driving the vehicle 100 via the remote control by using the estimated position and orientation of the vehicle 100 and transmit the generated control command to the vehicle 100, and the blind spot detectors 90 configured to detect the blind spot information including the three-dimensional point cloud data of the blind spot BS of the vehicle 100. The object existing in the blind spot BS generated in the surroundings of the vehicle 100 can be detected by the blind spot detector 90 that acquires the three-dimensional point cloud data of the blind spot BS.

The system 500 according to the present embodiment further includes the blind spot detector decision unit 318 configured to decide the blind spot detector 90 that can detect the blind spot information corresponding to the blind spot BS for each position of the vehicle 100 with respect to the vehicle detector 80 among the blind spot detectors 90. The blind spot information of the blind spot BS that dynamically changes in response to the traveling of the vehicle 100 can be detected by appropriately switching the blind spot detector 90 for each position of the vehicle 100 that travels.

The system 500 according to the present embodiment further includes the blind spot estimation unit 316 configured to estimate the position of the blind spot BS depending on the relative position of the vehicle 100 to the vehicle detector 80. The position of the blind spot BS that changes in response to the traveling of the vehicle 100 can be dynamically detected.

With the system 500 according to the present embodiment, the composite map generated by the composite map generation unit 322 is used for both the surrounding monitoring via the surrounding monitoring unit 324 and the movement control for the vehicle 100 via the controller 326. The processing of the traveling of the vehicle 100 and the processing of the surrounding monitoring for the vehicle 100 are easily simultaneously executed by using a common map using the three-dimensional point cloud data. In addition, the processing can be simplified more than in a case where the driving control for the vehicle 100 and the surrounding monitoring for the vehicle 100 are executed individually.

### B. Second Embodiment

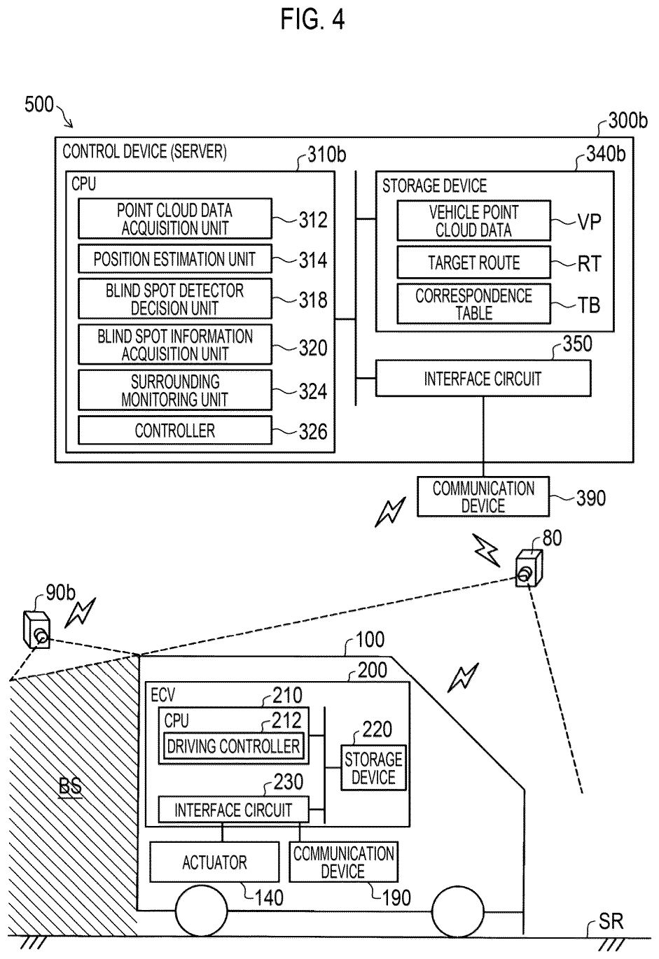

FIG. 4 is a diagram illustrating an overall configuration of a system 500 according to a second embodiment of the present disclosure. The system 500 according to the second embodiment is different from the system 500 according to the first embodiment in that a control device 300b is provided instead of the control device 300, and a blind spot detector 90b that uses a detector different from the LiDAR is provided instead of the blind spot detector 90 that uses the LiDAR, and the other configurations are the same.

The control device 300b is different from the control device 300 illustrated in the first embodiment in that a CPU 310b in which the functions of the blind spot estimation unit 316 and the composite map generation unit 322 are omitted is provided instead of the CPU 310, and a storage device 340b in which a correspondence table TB is further stored is provided, and the other configurations are the same. In the present embodiment, the composite map is not generated because the blind spot detector 90 is a detector different from the vehicle detector 80.

In the present embodiment, the blind spot detector 90b is the detector different from the LiDAR, and is, for example, a camera that acquires an image including the blind spot BS. The blind spot detector 90b may be a detector other than the camera or the LiDAR, and for example, various detectors that can detect the existence of the object in the blind spot BS, such as an infrared sensor, an ultrasound sensor, and a millimeter wave radar may be used.

In the first embodiment, the example has been described in which the blind spot detector 90 is the LiDAR and the same detector as the vehicle detector 80 is used. In contrast, as in the present embodiment, the blind spot detector 90 and the vehicle detector 80 may be different kinds of detectors. With the system 500 configured as described above, the object in the blind spot BS can be detected from a plurality of directions by using the different kinds of detectors. In addition, the process of generating the composite map can be omitted, and the processing speed of the system 500 can be improved.

The correspondence table TB indicates a correspondence relationship among the traveling position of the vehicle 100, the vehicle detector 80 that can detect the vehicle 100 at the traveling position, and the blind spot detector 90 that can detect the blind spot information of the blind spot BS generated in the surroundings of the vehicle 100 at the traveling position. Since the vehicle 100 travels on the travel road SR along the target route RT, a correspondence relationship between the vehicle detector 80 that can detect the vehicle 100 for each traveling position of the vehicle 100 and the blind spot detector 90 that can detect the blind spot information of the blind spot BS generated in the surroundings of the vehicle 100 for each traveling position may be settable in advance. In the example of FIG. 3, the correspondence table TB defines that a combination of the vehicle detector 80A and the blind spot detector 90A is used in a case where the traveling position of the vehicle 100 is the target route RT1, and a combination of the vehicle detector 80B and the blind spot detector 90B and a combination of the vehicle detector 80C and the blind spot detector 90C are used in a case where the traveling position of the vehicle 100 is the target route RT2. In the present embodiment, the correspondence table TB using this feature is prepared in advance.

With the system 500 according to the present embodiment, the correspondence table TB using the traveling position of the vehicle 100 is used, whereby the corresponding vehicle detector 80 and blind spot detector 90 can be decided by a simple method of acquiring the traveling position of the vehicle 100 by the position estimation unit 314 and the like. Therefore, the processing for deciding the vehicle detector 80 and the blind spot detector 90 corresponding to the traveling position of the vehicle 100 can be simplified, such as omitting the functions of the blind spot estimation unit 316 and the composite map generation unit 322.

### C. Third Embodiment

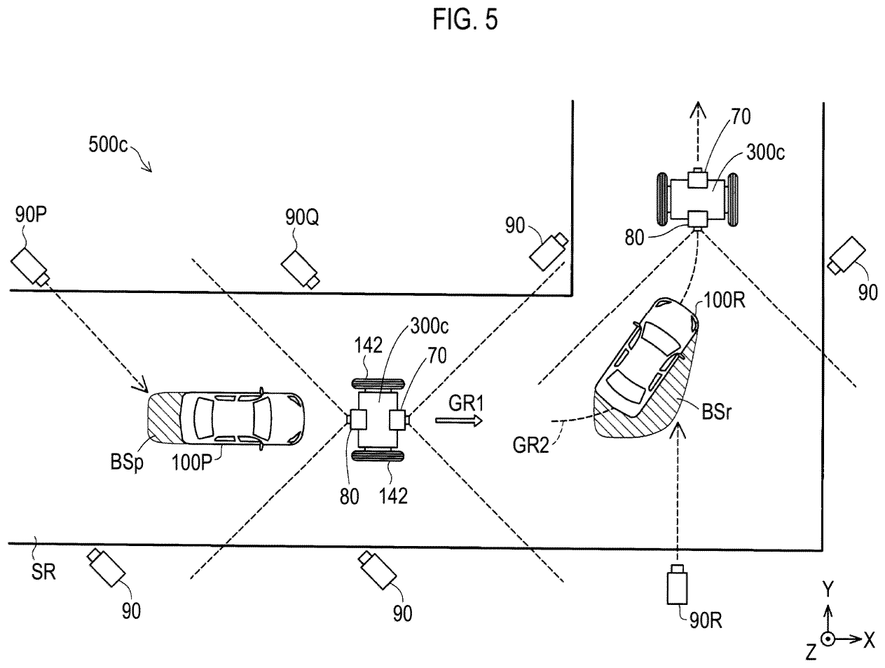

FIG. 5 is a diagram illustrating an example of an overall configuration of a system 500c according to a third embodiment in a top view. The system 500c according to the present embodiment is different from the system 500 according to the first embodiment in that a control device 300c is provided instead of the control device 300. The control device 300c is an unmanned transport vehicle also referred to as a so-called guide mobility. The control device 300c has a function of autonomously driving the vehicle 100 via the remote control as in the first embodiment, and a function of autonomously driving the control device 300c on the travel road SR. That is, the control device 300c autonomously drives the following vehicle 100 via the remote control while executing the autonomous driving on the travel road SR.

The control device 300c includes drive wheels 142 for autonomous driving,

a detector for autonomous driving 70, and the vehicle detector 80. Since the function of the vehicle detector 80 is the same as the function of the vehicle detector 80 illustrated in the first embodiment, the description thereof will be omitted. The detector for autonomous driving 70 is a distance measurement device, such as a camera or a LiDAR. The data acquired by the detector for autonomous driving 70 is used for simultaneous localization and mapping (SLAM) of self-position estimation and environment map creation for the autonomous driving of the control device 300c. A stereo camera, a monocular camera, an RGB-D camera (depth camera), or the like can be used as the camera. A ToF sensor or the like may be used instead of the camera or the LiDAR.

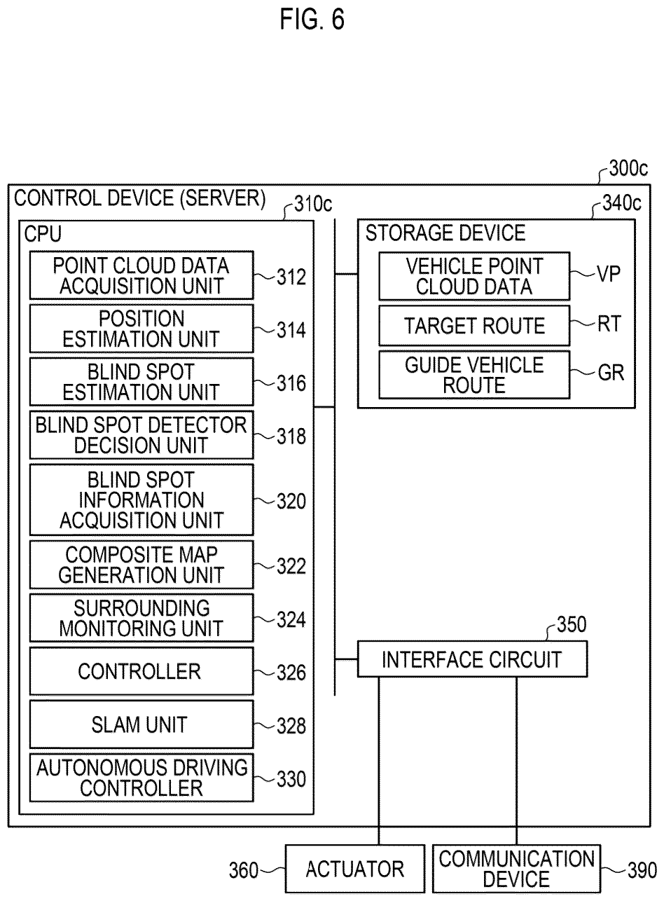

FIG. 6 is a block diagram illustrating a functional configuration of the control device 300c provided in the system 500c according to the third embodiment. The control device 300c is different from the control device 300 according to the first embodiment in that a CPU 310c that further functions as an SLAM unit 328 and an autonomous driving controller 330 is provided instead of the CPU 310, a storage device 340c in which a guide vehicle route GR is further stored is provided instead of the storage device 340, and an actuator 360 is further provided, and the other functions are the same. The guide vehicle route GR is a predetermined target route on which the control device 300c should travel.

The actuator 360 includes actuators of a drive device, a steering device, and a braking device for the autonomous driving of the control device 300c, respectively. The drive device includes a battery, a traveling motor driven by power of the battery, and the drive wheels 142 rotated by the traveling motor.

The SLAM unit 328 executes the SLAM using the data detected by the detector for autonomous driving 70 to execute the generation of a map for autonomous driving of the control device 300c. The autonomous driving controller 330 autonomously drives the control device 300c by controlling the actuator 360. The autonomous driving controller 330 uses the generated map to autonomously drive the control device 300c along the guide vehicle route GR stored in the storage device 340c.

As illustrated in FIG. 5, the blind spot detectors 90 including blind spot detectors 90P, 90Q, 90R are installed in the surroundings of the travel road SR. In the example of FIG. 5, the vehicle detector 80 is solely mounted on the control device 300c, but may be further installed in the surroundings of the travel road SR, similarly to the blind spot detector 90.

As illustrated on a left side of FIG. 5, when the control device 300c travels along the linear guide vehicle route GR1, a vehicle 100P is induced by the remote control of the control device 300c to travel on the same traveling route as the control device 300c. In this case, a blind spot BSp that is not detected by the vehicle detector 80 may be generated, for example, on an opposite side of the vehicle 100P with respect to the control device 300c, that is, a back side of the vehicle 100P. The blind spot estimation unit 316 estimates a position of the blind spot BSp, and the blind spot detector decision unit 318 decides the blind spot detector 90P that can detect the blind spot BSp. When the vehicle 100P further travels, the blind spot BSp leaves a detection range of the blind spot detector 90A. In this case, the blind spot detector is switched to, for example, the blind spot detector 90Q by the blind spot detector decision unit 318.

Further, as illustrated on a right side of FIG. 5, when the control device 300c travels along a guide vehicle route GR2 in a curved state, for example, a blind spot BSr that cannot be detected by the vehicle detector 80 is generated over a back surface side and a side surface side of the vehicle 100Q. In this case, the blind spot detector decision unit 318 decides, for example, the blind spot detector 90R that can detect blind spot information of the blind spot BSr.

As described above, with the system 500c according to the present embodiment, the control device 300c on which the vehicle detector 80 for detecting the vehicle 100 is mounted is configured to perform the autonomous driving. The system 500c according to the present embodiment can acquire the blind spot information by dynamically switching the blind spot detector 90 even in a case where the blind spot BS in the surroundings of the vehicle 100 dynamically changes due to the autonomous driving of the control device 300c and the autonomous driving of the vehicle 100 via the remote control.

### D. Fourth Embodiment

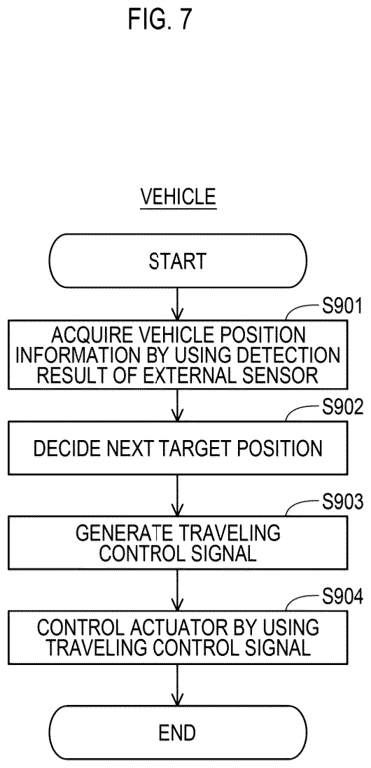

FIG. 7 is a flowchart illustrating a processing procedure of traveling control for a vehicle according to a fourth embodiment. Since the device configuration of the vehicle according to the present embodiment is the same as the device configuration in the first embodiment, the vehicle according to the present embodiment is described as the vehicle 100 for convenience. In the fourth embodiment, the control devices 300, 300b, 300c according to the first to third embodiments are mounted on the vehicle 100. That is, in the fourth embodiment, the vehicle 100 has the functions of the CPUs 310, 310b, 310c executed in the first to third embodiments and the data stored in the storage devices 340, 340b, 340c. In step S901, the vehicle 100 acquires the vehicle position information by using the detection result output from the vehicle detector 80 as the external sensor. In step S902, the vehicle 100 decides the target position to which the vehicle 100 should to head next. In step S903, the vehicle 100 generates the traveling control signal for causing the vehicle 100 to travel toward the decided target position. In step S904, the vehicle 100 controls the actuator of the vehicle 100 by using the generated traveling control signal, to cause the vehicle 100 to travel in accordance with the parameter indicated by the traveling control signal. The vehicle 100 repeatedly executes the acquisition of the vehicle position information, the decision of the target position, the generation of the traveling control signal, and the control of the actuator at a predetermined cycle. With the traveling control according to the present embodiment, the vehicle 100 can be caused to travel via the autonomous control for the vehicle 100 without the need to remotely control the vehicle 100 via the control devices 300, 300b, 300c as the servers.

### E. Other Embodiments

(E1) In the above-described embodiment, the example has been described in which the vehicle detector 80 is the LiDAR. In contrast, as the vehicle detector 80, a camera that acquires an image of the vehicle 100 as the vehicle information may be used. The image acquired by the camera is used, for example, for acquiring various information used for the remote control, such as the position of the vehicle 100 and the orientation of the vehicle 100, by image analysis of the control device 300, such as object recognition using a machine learning model.

(E2) In each of the above-described embodiments, the example has been described in which the systems 500, 500c include the blind spot detectors 90, but may include a single blind spot detector 90. In a case where a single blind spot detector 90 is used, solely a determination of whether or not to use the blind spot detector 90 may be executed instead of the decision of the blind spot detector 90, and in this case, the function of the blind spot detector decision unit 318 may be omitted, and the blind spot detector decision unit 318 may determine whether or not to use the blind spot detector 90. Although the example has been described in which the systems 500, 500c include the vehicle detectors 80, the systems 500, 500c may include a single vehicle detector 80.

(E3) In the first embodiment, the example has been described in which the generated composite map is used for both the surrounding monitoring via the surrounding monitoring unit 324 and the driving control for the vehicle 100 via the controller 326. In contrast, the composite map may be used solely for the surrounding monitoring. The surrounding monitoring using solely the blind spot information may be executed without generating the composite map, and the surrounding monitoring using the blind spot information and the vehicle information may be executed individually. When the composite map is not generated, the autonomous driving of the vehicle 100 via the remote control can be implemented by using the vehicle information acquired by the vehicle detector 80.

(E4) In each of the above-described embodiments, the example has been described in which the vehicle 100 is the passenger car, the truck, the bus, or the construction vehicle. Note that the vehicle 100 is not limited to these examples, and may include various vehicles, such as a motorcycle, a four-wheeled vehicle, and a train. In addition, the various mobile bodies other than the vehicle 100 may be used. The “mobile body” means a movable object. The mobile body includes, for example, a vehicle, an electric vertical take-off and landing (so-called flying car), a ship, an airplane, a robot, and a linear motor car. In this case, the expression of “vehicle” and “car” in the present disclosure can be appropriately replaced with “mobile body”, and the expression of “travel” can be appropriately replaced with “move”.

(E5) The vehicle 100 need solely have a configuration that can be moved by the unmanned driving. For example, the platform may have the following configuration. Specifically, the vehicle 100 need solely be configured to exhibit the functions of “traveling”, “turning”, and “stopping” via the unmanned driving. That is, the vehicle 100 need solely include at least the control device that controls the traveling of the vehicle 100, and the actuator, such as the drive device, the steering device, and the braking device. In a case where the vehicle 100 acquires the information from the outside for the unmanned driving, the vehicle 100 need solely further include a communication device. That is, the vehicle 100 that can be moved by the unmanned driving need not be equipped with at least a part of the interior components, such as a driver's seat and a dashboard, need not be equipped with at least a part of the exterior components, such as a bumper and a fender mirror, and need not be equipped with a bodyshell. In this case, the remaining components, such as the bodyshell, may be equipped on the vehicle 100 while the vehicle 100 is shipped from the factory, or the remaining components, such as the bodyshell, may be equipped on the vehicle 100 after the vehicle 100 is shipped from the factory in a state where the remaining components, such as the bodyshell, are not equipped on the vehicle 100. Each component may be equipped from any direction, such as an upper side, a lower side, a front side, a rear side, a right side, or a left side of the vehicle 100, and may be equipped from the same direction or different directions. The position decision can be made for the form of the platform in the same manner as the vehicle 100 in each of the above-described embodiments.

(E6) In the first to third embodiments, the servers 300, 300b, 300c execute the processing from the acquisition of the vehicle position information to the generation of the traveling control signal. In contrast, the vehicle 100 may execute at least a part of the processing from the acquisition of the vehicle position information to the generation of the traveling control signal. For example, the following forms (1) to (3) may be used.

(1) The servers 300, 300b, 300c may acquire the vehicle position information, decide the target position to which the vehicle 100 should head next, and generate the route from the current position of the vehicle 100 indicated by the acquired vehicle position information to the target position. The servers 300, 300b, 300c may generate a route to the target position between the current position and the destination, or may generate a route to the destination. The servers 300, 300b, 300c may transmit the generated route to the vehicle 100. The vehicle 100 may generate the traveling control signal for causing the vehicle 100 to travel on the route received from the servers 300, 300b, 300c, and control the actuator of the vehicle 100 by using the generated traveling control signal.

(2) The servers 300, 300b, 300c may acquire the vehicle position information, and transmit the acquired vehicle position information to the vehicle 100. The vehicle 100 may decide the target position to which the vehicle 100 should head next, generate a route from the current position of the vehicle 100 represented by the received vehicle position information to the target position, generate a traveling control signal such that the vehicle 100 travels on the generated route, and control the actuator of the vehicle 100 by using the generated traveling control signal.

(3) In the above-described forms (1) and (2), an internal sensor may be mounted on the vehicle 100, and a detection result output from the internal sensor may be used for at least one of the generation of the route and the generation of the traveling control signal. The internal sensor is a sensor mounted on the vehicle 100. Specifically, the internal sensor may include, for example, a camera, a LiDAR, a millimeter wave radar, an ultrasound sensor, a GPS sensor, an acceleration sensor, and a gyro sensor. For example, in the above-described form (1), the server 300 may acquire the detection result of the internal sensor and reflect the detection result of the internal sensor in the route when generating the route. In the above-described form (1), the vehicle 100 may acquire the detection result of the internal sensor and reflect the detection result of the internal sensor to the traveling control signal when the traveling control signal is generated. In the above-described form (2), the vehicle 100 may acquire the detection result of the internal sensor and reflect the detection result of the internal sensor to the route when the route is generated. In the above-described form (2), the vehicle 100 may acquire the detection result of the internal sensor and reflect the detection result of the internal sensor to the traveling control signal when the traveling control signal is generated.

(E7) In the above-described embodiment in which the vehicle 100 can travel via the autonomous control, the internal sensor may be mounted on the vehicle 100, and the detection result output from the internal sensor may be used in at least one of the generation of the route and the generation of the traveling control signal. For example, the vehicle 100 may acquire the detection result of the internal sensor and reflect the detection result of the internal sensor to the route when the route is generated. The vehicle 100 may acquire the detection result of the internal sensor and reflect the detection result of the internal sensor to the traveling control signal when the traveling control signal is generated.

(E8) In each of the above-described embodiments, the servers 300, 300b, 300c automatically generate the traveling control signal to be transmitted to the vehicle 100. In contrast, the server 300 may generate the traveling control signal to be transmitted to the vehicle 100 in response to an operation of an external operator who is located outside the vehicle 100. For example, the external operator may operate an operation device including a display that displays the captured image output from the external sensor, a steering wheel, an accelerator pedal, and a brake pedal for remotely operating the vehicle 100, and a communication device that communicates with the server 300 via wired communication or wireless communication, and the servers 300, 300b, 300c may generate the traveling control signal in response to the operation applied to the operation device.

(E9) The vehicle 100 may be manufactured by combining a plurality of modules. The module means a unit configured by one or more components assembled depending on the configuration or the function of the vehicle 100. For example, the platforms of the vehicle 100 may be manufactured by combining a front module that constitutes a front portion of the platform, a center module that constitutes a center portion of the platform, and a rear module that constitutes a rear portion of the platform. In addition, the number of the modules constituting the platform is not limited to three, and may be two or less or four or more. In addition to or instead of the platform, a portion of the vehicle 100 that is different from the platform may be modularized. In addition, various modules may include any exterior component, such as a bumper or a grille, or any interior component, such as the seat or a console. In addition, in addition to the vehicle 100, a mobile body of any aspect may be manufactured by combining the modules. Such a module may be manufactured by joining the components via welding, a fastener, or the like, or may be manufactured by integrally molding at least a part of the module as one component by casting. A molding method of integrally molding at least a part of the modules as one component is also called giga casting or mega casting. By using the giga casting, cach unit of the mobile body that has been formed by joining a plurality of components in the related art can be formed as one component. For example, the front module, the center module, and the rear module may be manufactured by using giga casting.

(E10) The transport of the vehicle 100 using the traveling of the vehicle 100 via the unmanned driving is also referred to as “autonomous transport”. A configuration for implementing the autonomous transport is also referred to as “vehicle remote control autonomous driving transport system”. A production method of producing the vehicle 100 by using the autonomous transport is also referred to as “autonomous production”. In the autonomous production, for example, at the factory that manufactures the vehicle 100, at least a part of the transport of the vehicle 100 is implemented by the autonomous transport.

The present disclosure is not limited to the above-described embodiments, and can be implemented with various configurations without departing from the spirit of the present disclosure. For example, the technical features in the embodiments corresponding to the technical features in each form described in the section of SUMMARY can be replaced or combined as appropriate to solve some or all of the above objects, or to achieve some of or all the above effects. In a case where the technical features are not described as necessary features in the present specification, the features can be deleted as appropriate.

What is claimed is:

1. A system configured to move a mobile body via unmanned driving, the system comprising:
at least one mobile body detector configured to detect mobile body information including at least any one of an image of the mobile body and three-dimensional point cloud data of the mobile body;
a position estimation unit configured to estimate at least any one of a position and an orientation of the mobile body by using the detected mobile body information;
a controller configured to generate a control command for causing the mobile body to travel by using the estimated position and orientation of the mobile body; and
at least one blind spot detector configured to detect blind spot information including at least any one of an image of a blind spot of the mobile body that is not detected by the mobile body detector, three-dimensional point cloud data of the blind spot, and existence of an object in the blind spot.

2. The system according to claim 1, wherein:
the at least one blind spot detector includes a plurality of the blind spot detectors; and
the system further comprises a blind spot detector decision unit configured to decide the blind spot detector that is able to detect the blind spot information corresponding to the blind spot for each position of the mobile body with respect to the mobile body detector among the blind spot detectors.

3. The system according to claim 1, further comprising a blind spot estimation unit configured to estimate a position of the blind spot depending on a relative position of the mobile body to the mobile body detector.

4. The system according to claim 3, wherein the blind spot estimation unit is configured to estimate the position of the blind spot by regarding, among straight lines directed from the mobile body detector toward the mobile body and passing through the mobile body, a set on a side opposite to the mobile body detector across the mobile body as the blind spot.

5. The system according to claim 1, wherein the at least one mobile body detector and the at least one blind spot detector include different kinds of detectors.

6. The system according to claim 5, wherein:
the at least one mobile body detector is any one of a distance measurement device and a camera; and
the at least one blind spot detector is the other of the distance measurement device and the camera.

7. The system according to claim 1, further comprising:
a composite map generation unit configured to generate a composite map by composing the detected mobile body information and the detected blind spot information; and
a surrounding monitoring unit configured to monitor surroundings of the mobile body,
wherein the generated composite map is used for both surrounding monitoring via the surrounding monitoring unit and movement control for the mobile body via the controller.

8. A method of moving a mobile body via unmanned driving, the method comprising:
detecting, via at least one mobile body detector, mobile body information including at least any one of an image of the mobile body and three-dimensional point cloud data of the mobile body;
estimating at least any one of a position and an orientation of the mobile body by using the detected mobile body information;
generating a control command for causing the mobile body to travel by using the estimated position and orientation of the mobile body; and
detecting, via at least one blind spot detector, blind spot information including at least any one of an image of a blind spot of the mobile body that is not detected by the mobile body detector, three-dimensional point cloud data of the blind spot, and existence of an object in the blind spot.
